(19) United States
(12) Patent Application Publication
(10) Pub. No.: US 2019/0135097 A1
(43) Pub. Date: May 9, 2019

(54) Vehicle Balloon Assembly

(71) Applicant: Gary Steinberg, Keensburg, CO (US)

(72) Inventor: Gary Steinberg, Keensburg, CO (US)

(21) Appl. No.: 15/802,508

(22) Filed: Nov. 3, 2017

(51) Int. Cl. B60J 11/04

(52) U.S. Cl. CPC B60J 11/04

(57) ABSTRACT

A vehicle balloon assembly for protecting a vehicle from hail damage includes balloon that is selectively positioned to cover a vehicle protect the vehicle from hail damage. A blower is fluidly coupled to the balloon and the blower selectively inflates and deflates the balloon. In this way the balloon absorbs impact energy from hail. A remote control is provided and the remote control is in electrical communication with the blower. Thus, the remote control selectively turns the blower on and off.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to balloon devices and more particularly pertains to a new balloon device for protecting a vehicle from hail damage.

### BRIEF SUMMARY OF THE INVENTION

An embodiment of the disclosure meets the needs presented above by generally comprising a balloon that is selectively positioned to cover a vehicle protect the vehicle from hail damage. A blower is fluidly coupled to the balloon and the blower selectively inflates and deflates the balloon. In this way the balloon absorbs impact energy from hail. A remote control is provided and the remote control is in electrical communication with the blower. Thus, the remote control selectively turns the blower on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a vehicle balloon assembly according to an embodiment of the disclosure.

FIG. 2 is a back view of an embodiment of the disclosure.

FIG. 3 is a bottom view of an embodiment of the disclosure.

FIG. 4 is a cross sectional view taken along line 4-4 of FIG. 3 of an embodiment of the disclosure.

FIG. 5 is a phantom in-use view of an embodiment of the disclosure.

FIG. 6 is a schematic view of an embodiment of the disclosure.

### DETAILED DESCRIPTION OF THE INVENTION

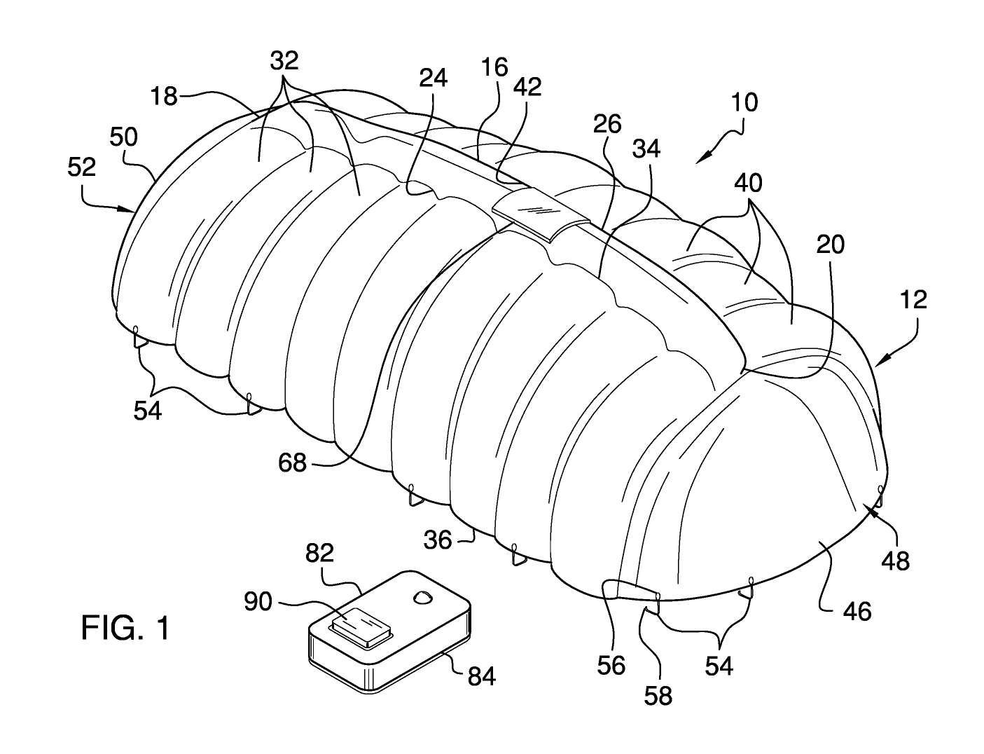

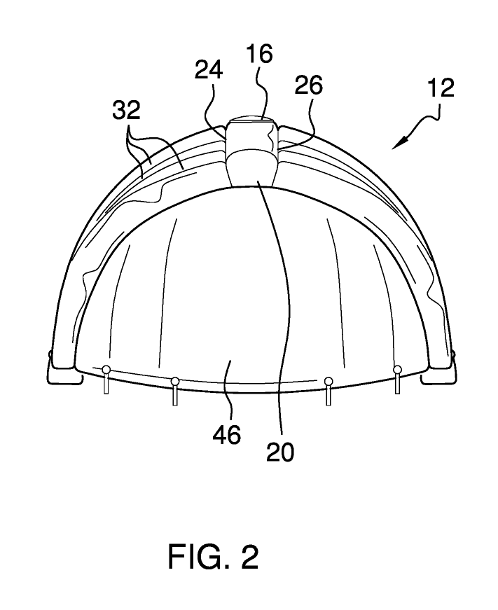

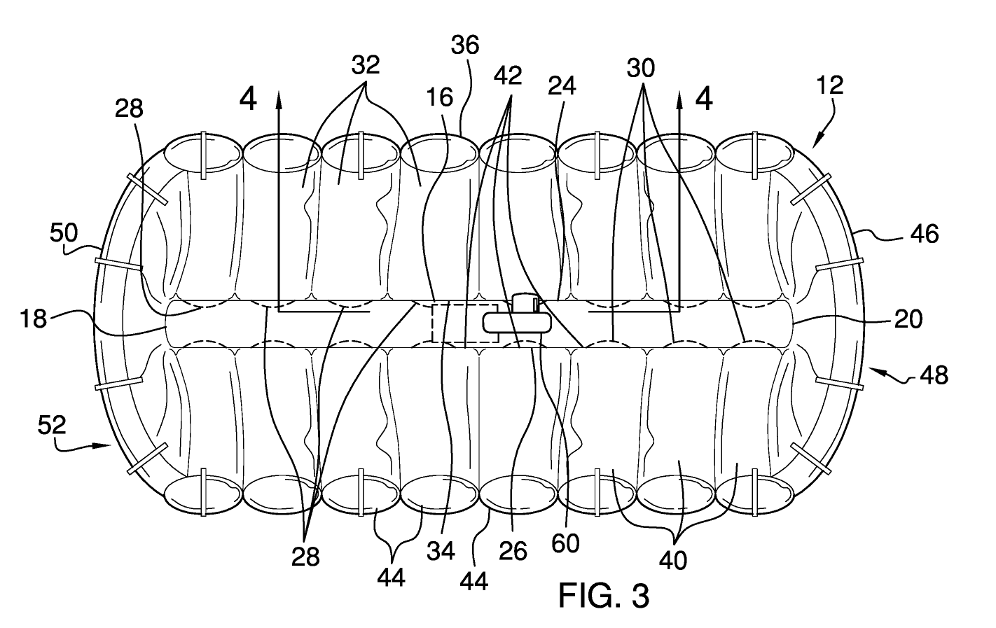

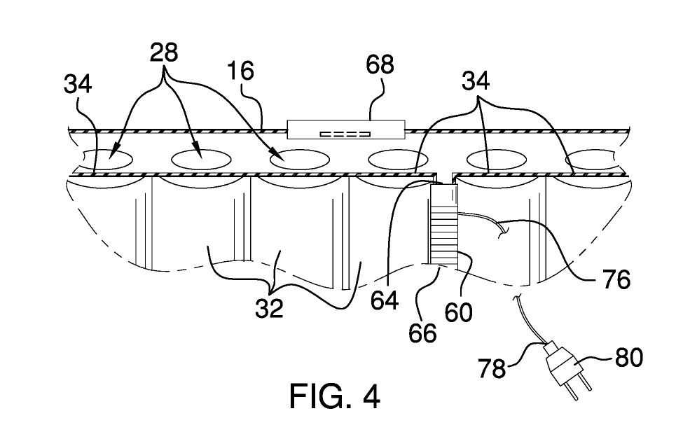

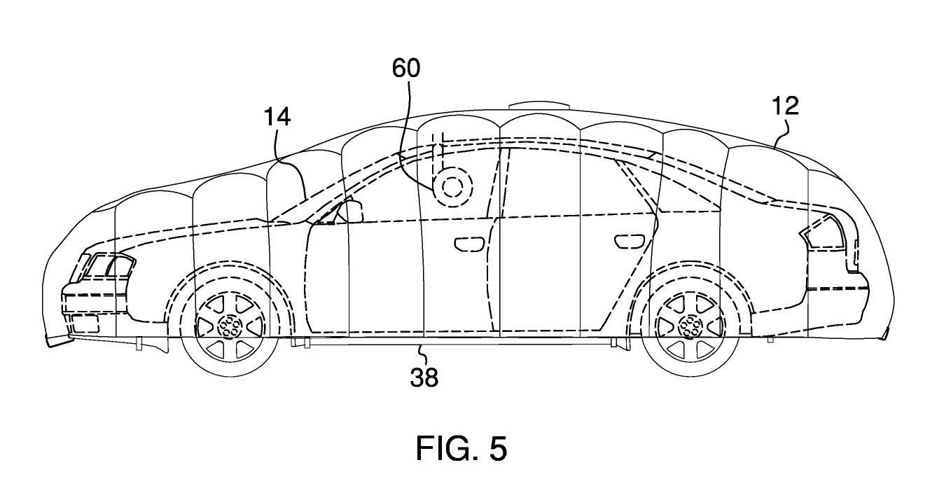

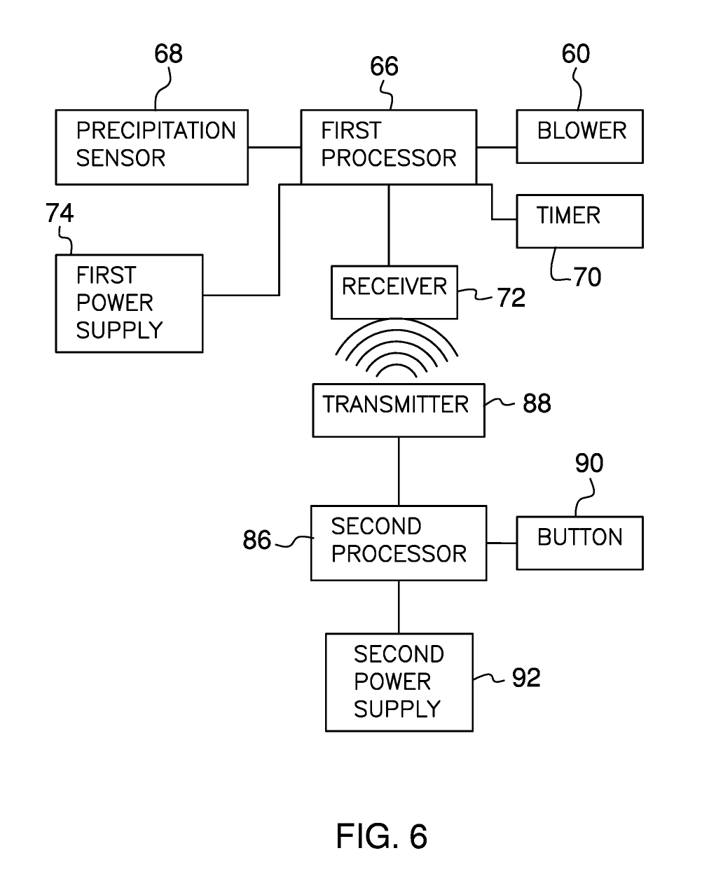

With reference now to the drawings, and in particular to FIGS. 1 through 6 thereof, a new balloon device embodying the principles and concepts of an embodiment of the disclosure and generally designated by the reference numeral 10 will be described.

As best illustrated in FIGS. 1 through 6, the vehicle balloon assembly 10 generally comprises a balloon 12 that is selectively positioned to cover a vehicle 14. In this way the balloon 12 may protect the vehicle 14 from hail damage. The vehicle 14 may be a car, pickup and any other type of motorized vehicle 14. The balloon 12 is comprised of a fluid impermeable and tear resistant material.

The balloon 12 comprises a first tube 16 that has a first end 18, a second end 20 and an outer wall 22. Each of the first end 18 and the second end 20 is open and the outer wall 22 has a first lateral side 24 and a second lateral side 26. The first lateral side 24 has a plurality of first openings 28 and each of the first openings 28 extends into an interior of the first tube 16. The first openings 28 are spaced apart from each other and are distributed along the first tube 16. The second lateral side 26 has a plurality of second openings 30 extending into the interior of the first tube 16. The second openings 30 are spaced apart from each other and are distributed along the first tube 16. The first tube 16 lies on a top of the vehicle 14 when the balloon 12 is positioned to cover the vehicle 14.

A plurality of second tubes 32 is provided and each of the second tubes 32 has a first end 34 and a second end 36. The first end 34 of each of the second tubes 32 is open and the first end 34 of each of the second tubes 32 is coupled to the first lateral side 24 of the first tube 16. Each of the second tubes 32 is aligned with an associated one of the first openings 28 such that each of the second tubes 32 is in fluid communication with the first tube 16. Moreover, each of the second tubes 32 is coupled to an adjacent one of the second tubes 32 such that the second tubes 32 form a fluid impermeable barrier. The second end 36 of each of the second tubes 32 is aligned with a bottom side 38 of the vehicle 14 when the balloon 12 is positioned over the vehicle 14.

A plurality of third tubes 40 is provided and each of the third tubes 40 has a first end 42 and a second end 44. The first end 42 of each of the third tubes 40 is open and the first end 42 of each of the third tubes 40 is coupled to the second lateral side 26 of the first tube 16. Each of the third tubes 40 is aligned with an associated one of the second openings 30 such that each of the third tubes 40 is in fluid communication with the first tube 16. Moreover, each of the third tubes 40 is coupled to an adjacent one of the third tubes 40 such that the plurality of third tubes 40 forms a fluid impermeable barrier. The second end 44 of each of the third tubes 40 is aligned with the bottom side 38 of the vehicle 14 when the balloon 12 is positioned over the vehicle 14.

A first pillow 46 is coupled to the first end 18 of the first tube 16 such that the first pillow 46 is in fluid communication with the first tube 16. The first pillow 46 extends between an associated pair of the second 32 and third 40 tubes. In this way the first pillow 46 defines a first end 48 of the balloon 12. A second pillow 50 is coupled to the second end 20 of the first tube 16 such that the second pillow 50 is in fluid communication with the first tube 16. The second pillow 50 extends between an associated pair of the second 32 and third 40 tubes. In this way the second pillow 50 defines a second end 52 of the balloon 12.

A plurality of hooks 54 is provided and each of the hooks 54 is coupled to the balloon 12. Each of the hooks 54 is selectively coupled to the vehicle 14 thereby retaining the balloon 12 on the vehicle 14. Each of the hooks 54 has a first end 56 and a second end 58. The first end 56 of each of the hooks 54 is coupled to the second end 20 of an associated one of the second 32 and third 40 tubes. The second end 20 of each of the hooks 54 is manipulated engage the bottom side 38 of the vehicle 14.

A blower 60 is provided and the blower 60 is fluidly coupled to the balloon 12 to selectively inflate and deflate the balloon 12. The balloon 12 absorbs impact energy from the hail when the balloon 12 is inflated. The blower 60 has an input 62 and an output 64, and the output 62 is fluidly coupled to the first tube 16. The input draws air inwardly and the output urges air outwardly when the blower 60 is turned on. The blower 60 selectively inflates each of the first tube 16, the second tubes 32, the third tubes 40, the first pillow 46 and the second pillow 50. Moreover, the balloon 12 forms a dome over the vehicle 14 when the balloon 12 is inflated. The blower 60 may be an electric blower or the like.

A first processor 66 is coupled to the blower 60 and the first processor 66 selectively generates an inflation sequence and a deflation sequence. The blower 60 is turned on to inflate the balloon 12 when the first processor 66 generates the inflation sequence. Additionally, the blower 60 is turned on to deflate the balloon 12 when the first processor 66 generates the deflation sequence. The first processor 66 may be an electronic processor or the like.

A precipitation sensor 68 is coupled to the outer wall 22 of the first tube 16 such that the precipitation sensor 68 is positioned to be exposed to precipitation. The precipitation sensor 68 is electrically coupled to the first processor 66. Moreover, the first processor 66 generates the inflation sequence when the precipitation sensor 68 senses precipitation. The precipitation sensor 68 may be an electronic moisture sensor or the like.

A timer 70 is coupled to the blower 60 and the timer 70 is electrically coupled to the first processor 66. The timer 70 actuates the first processor 66 to turn the blower 60 off after a pre-determined duration of time. The timer 70 may be an electronic timer 70 or the like and the pre-determined duration of time may be a duration of time sufficient for the blower 60 to completely inflate the balloon 12. A receiver 72 is coupled to the blower 60 and the receiver 72 is electrically coupled to the first processor 66. The receiver 72 may be a radio frequency receiver 72 or the like.

A first power supply 74 is coupled to the blower 60 and the first power supply 74 is electrically coupled to the first processor 66. The first power supply 74 comprises a power cord 76 extending outwardly from the blower 60. The power cord 76 has a distal end 78 with respect to the blower 60 and a plug 80 is electrically coupled thereto. The plug 80 may be a cigarette lighter adapter of the like and the plug 80 is selectively electrically coupled to a cigarette lighter in the vehicle 14.

A remote control 82 is provided and the remote control 82 is selectively manipulated. The remote control 82 is in electrical communication with the blower 60 such that the remote control 82 selectively turns the blower 60 on and off. The remote control 82 comprises a housing 84 and a second processor 86 that is positioned within the housing 84. The second processor 86 selectively generates an activation sequence and the second processor 86 may be an electronic processor or the like.

A transmitter 88 is positioned within the housing 84. The transmitter 88 is electrically coupled to the second processor 86 such that the transmitter 88 receives the activation sequence from the second processor 86. The transmitter 88 is in electrical communication with the receiver 72. Moreover, the first processor 66 generates the inflation sequence when the transmitter 88 communicates the activation sequence to the receiver 72. The transmitter 88 may be a radio frequency transmitter 88 or the like.

A button 90 is movably coupled to the housing 84 and the button 90 is selectively manipulated. The button 90 is electrically coupled to the second processor 86 and the second processor 86 generates the activation sequence when the button 90 is manipulated. A second power supply 92 is positioned within the housing 84 and the second power supply 92 is electrically coupled to the second processor 86. The second power supply 92 comprises at least one battery.

In use, the balloon 12 is positioned to cover the vehicle 14 when rain and hail is forecasted. Each of the hooks 54 is manipulated to engage the bottom side 38 of the vehicle 14 to retain the balloon 12 on the vehicle 14. The first processor 66 generates the inflation sequence when the precipitation sensor 68 senses the precipitation. Thus, the blower 60 automatically inflates the balloon 12 thereby protecting the vehicle 14 from potential hail damage. Additionally, the button 90 on the remote control 82 is selectively manipulated to manually inflate the balloon 12 regardless if with precipitation sensor 68 senses the precipitation. The button 90 on the remote control 82 is selectively manipulated to turn the blower 60 off. Thus, the balloon 12 deflates and the balloon 12 is removed from the vehicle 14 thereby facilitating the vehicle 14 to be driven.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle balloon assembly being configured to be selectively inflated thereby protecting a vehicle from hail damage, said assembly comprising:
a balloon being selectively positioned to cover a vehicle wherein said balloon is configured to protect the vehicle from hail damage;
a blower being fluidly coupled to said balloon wherein said blower is configured to selectively inflate and deflate said balloon;
a remote control being configured to be manipulated, said remote control being in electrical communication with said blower such that said remote control selectively turns said blower on and off;
a first processor being coupled to said blower, said first processor selectively generating an inflation sequence and a deflation sequence, said blower being turned on to inflate said balloon when said first processor generates said inflation sequence, said blower being turned on to deflate said balloon when said first processor generates said deflation sequence; and
a precipitation sensor being coupled to an outer wall of a first tube of said balloon wherein said precipitation sensor is configured to be exposed to precipitation, said precipitation sensor being electrically coupled to said first processor, said first processor generating said inflation sequence when said precipitation sensor senses precipitation.

2. The assembly according to claim 1, further comprising said first tube having a first end and a second end, each of said first end and said second end being open, said outer wall having a first lateral side and a second lateral side, said first tube being configured to lie on a top of the vehicle when said balloon is positioned to cover the vehicle.

3. A vehicle balloon assembly being configured to be selectively inflated thereby protecting a vehicle from hail damage, said assembly comprising:
a balloon being selectively positioned to cover a vehicle wherein said balloon is configured to protect the vehicle from hail damage;
a blower being fluidly coupled to said balloon wherein said blower is configured to selectively inflate and deflate said balloon; and
a remote control being configured to be manipulated, said remote control being in electrical communication with said blower such that said remote control selectively turns said blower on and off;
said balloon comprising a first tube having a first end, a second end, and an outer wall, each of said first end and said second end being open, said outer wall having a first lateral side and a second lateral side, said first tube being configured to lie on a top of the vehicle when said balloon is positioned to cover the vehicle;
said first lateral side has a plurality of first openings, each of said first openings extending into an interior of said first tube, said first openings being spaced apart from each other and being distributed along said first tube; and
said second lateral side has a plurality of second openings, said second openings being spaced apart from each other and being distributed along said first tube.

4. The assembly according to claim 3, further comprising a plurality of second tubes, each of said second tubes having a first end and a second end, said first end of each of said second tubes being open, said first end of each of said second tubes being coupled to said first lateral side of said first tube, each of said second tubes being aligned with an associated one of said first openings such that each of said second tubes is in fluid communication with said first tube.

5. The assembly according to claim 4, wherein each of said second tubes is coupled to an adjacent one of said second tubes such that said second tubes forms a fluid impermeable barrier, said second end of each of said second tubes being configured to be aligned with a bottom side of the vehicle when said balloon is positioned to cover the vehicle.

6. The assembly according to claim 3, further comprising a plurality of third tubes, each of said third tubes having a first end and a second end, said first end of each of said third tubes being open, said first end of each of said third tubes being coupled to said second lateral side of said first tube, each of said third tubes being aligned with an associated one of said second openings such that each of said third tubes is in fluid communication with said first tube.

7. The assembly according to claim 6, wherein each of said third tubes is coupled to an adjacent one of said third tubes such that said plurality of third tubes forms a fluid impermeable barrier, said second end of each of said third tubes being configured to be aligned with a bottom side of the vehicle when said balloon is positioned to cover the vehicle.

8. The assembly according to claim 7, further comprising:
a first pillow being coupled to said first end of said first tube such that said first pillow is in fluid communication with said first tube, said first pillow extending between an associated pair of said second and third tubes such that said first pillow defines a first end of said balloon; and
a second pillow being coupled to said second end of said first tube such that said second pillow is in fluid communication with said first tube, said second pillow extending between an associated pair of said second and third tubes such that said second pillow defines a second end of said balloon.

9. The assembly according to claim 8, wherein:
said balloon includes a plurality of second tubes; and
said blower has an input and an output, said output being fluidly coupled to said first tube, said blower selectively inflating each of said first tube, said second tubes, said third tubes, said first pillow and said second pillow such that said balloon forms a dome over the vehicle.

10. (canceled)

11. (canceled)

12. A vehicle balloon assembly being configured to be selectively inflated thereby protecting a vehicle from hail damage, said assembly comprising:
a balloon being selectively positioned to cover a vehicle wherein said balloon is configured to protect the vehicle from hail damage;
a blower being fluidly coupled to said balloon wherein said blower is configured to selectively inflate and deflate said balloon;
a remote control being configured to be manipulated, said remote control being in electrical communication with said blower such that said remote control selectively turns said blower on and off;
a first processor being coupled to said blower, said first processor selectively generating an inflation sequence and a deflation sequence, said blower being turned on to inflate said balloon when said first processor generates said inflation sequence, said blower being turned on to deflate said balloon when said first processor generates said deflation sequence; and
a timer being coupled to said blower, said timer being electrically coupled to said first processor, said timer actuating said first processor to turn said blower off after a pre-determined duration of time.

13. The assembly according to claim 1, further comprising a receiver being coupled to said blower, said receiver being electrically coupled to said first processor.

14. The assembly according to claim 1, further comprising a first power supply being coupled to said blower, said first power supply being electrically coupled to said first processor, said first power supply comprising a power cord extending outwardly from said blower, said power cord having a distal end with respect to said blower, said distal end having a plug being electrically coupled thereto, said plug being configured to be electrically coupled to the vehicle.

15. The assembly according to claim 1, wherein said remote control comprises:
a housing; and
a second processor being positioned within said housing, said second processor selectively generating an activation sequence.

16. The assembly according to claim 15, further comprising:
a first processor selectively generating an inflation sequence;
a receiver being electrically coupled to said first processor; and
a transmitter being positioned within said housing, said transmitter being electrically coupled to said second processor such that said transmitter receives said activation sequence from said second processor, said transmitter being in electrical communication with said receiver, said first processor generating said inflation sequence when said transmitter communicates said activation sequence to said receiver.

17. The assembly according to claim 16, further comprising:
a button being movably coupled to said housing wherein said button is configured to be manipulated, said button being electrically coupled to said second processor, said second processor generating said activation sequence when said button is manipulated; and
a second power supply being positioned within said housing, said second power supply being electrically coupled to said second processor, said second power supply comprising at least one battery.

18. The assembly of claim 1, further comprising:
said balloon comprising:
said first tube having a first end and a second end, each of said first end and said second end being open, said outer wall having a first lateral side and a second lateral side, said first lateral side having a plurality of first openings, each of said first openings extending into an interior of said first tube, said first openings being spaced apart from each other and being distributed along said first tube, said second lateral side having a plurality of second openings, said second openings being spaced apart from each other and being distributed along said first tube, said first tube being configured to lie on a top of the vehicle when said balloon is positioned to cover the vehicle,
a plurality of second tubes, each of said second tubes having a first end and a second end, said first end of each of said second tubes being open, said first end of each of said second tubes being coupled to said first lateral side of said first tube, each of said second tubes being aligned with an associated one of said first openings such that each of said second tubes is in fluid communication with said first tube, each of said second tubes being coupled to an adjacent one of said second tubes such that said second tubes forms a fluid impermeable barrier, said second end of each of said second tubes being configured to be aligned with a bottom side of the vehicle when said balloon is positioned to cover the vehicle,
a plurality of third tubes, each of said third tubes having a first end and a second end, said first end of each of said third tubes being open, said first end of each of said third tubes being coupled to said second lateral side of said first tube, each of said third tubes being aligned with an associated one of said second openings such that each of said third tubes is in fluid communication with said first tube, each of said third tubes being coupled to an adjacent one of said third tubes such that said plurality of third tubes forms a fluid impermeable barrier, said second end of each of said third tubes being configured to be aligned with the bottom side of the vehicle when said balloon is positioned to cover the vehicle,
a first pillow being coupled to said first end of said first tube such that said first pillow is in fluid communication with said first tube, said first pillow extending between an associated pair of said second and third tubes such that said first pillow defines a first end of said balloon, and
a second pillow being coupled to said second end of said first tube such that said second pillow is in fluid communication with said first tube, said second pillow extending between an associated pair of said second and third tubes such that said second pillow defines a second end of said balloon;
a plurality of hooks, each of said hooks being coupled to said balloon, each of said hooks being configured to be coupled to the vehicle thereby retaining said balloon on the vehicle, each of said hooks having a first end and a second end, said first end of each of said hooks being coupled to said second end of an associated one of said second and third tubes, said second end of each of said hooks being configured to engage the bottom side of the vehicle;
said blower having an input and an output, said output being fluidly coupled to said first tube, said blower selectively inflating each of said first tube, said second tubes, said third tubes, said first pillow and said second pillow such that said balloon forms a dome over the vehicle;
a timer being coupled to said blower, said timer being electrically coupled to said first processor, said timer actuating said first processor to turn said blower off after a pre-determined duration of time;
a receiver being coupled to said blower, said receiver being electrically coupled to said first processor;
a first power supply being coupled to said blower, said first power supply being electrically coupled to said first processor, said first power supply comprising a power cord extending outwardly from said blower, said power cord having a distal end with respect to said blower, said distal end having a plug being electrically coupled thereto, said plug being configured to be electrically coupled to the vehicle; and
said remote control comprising:
a housing;
a second processor being positioned within said housing, said second processor selectively generating an activation sequence,
a transmitter being positioned within said housing, said transmitter being electrically coupled to said second processor such that said transmitter receives said activation sequence from said second processor, said transmitter being in electrical communication with said receiver, said first processor generating said inflation sequence when said transmitter communicates said activation sequence to said receiver;
a button being movably coupled to said housing wherein said button is configured to be manipulated, said button being electrically coupled to said second processor, said second processor generating said activation sequence when said button is manipulated, and
a second power supply being positioned within said housing, said second power supply being electrically coupled to said second processor, said second power supply comprising at least one battery.
